(19) United States
(12) Patent Application Publication
(10) Pub. No.: US 2024/0019582 A1
(43) Pub. Date: Jan. 18, 2024

(54) THREE-FREQUENCY CYCLE SLIP DETECTION METHOD OF BDS BASED ON DOPPLER INTEGRATION ASSISTANCE

(71) Applicant: Liaoning Technical University, Fuxin (CN)

(72) Inventors: Jianmin WANG, Fuxin (CN); Xingwang Wang, Fuxin (CN)

(21) Appl. No.: 18/080,295

(22) Filed: Dec. 13, 2022

(30) Foreign Application Priority Data
Jul. 13, 2022 (CN) 2022108185462

(51) Int. Cl. G01S 19/24; G01S 19/29

(52) U.S. Cl. CPC G01S 19/246; G01S 19/29

(57) ABSTRACT

A three-frequency cycle slip detection method of a BDS based on Doppler integration assistance includes: performing an epoch integration on three-frequency Doppler observation values to obtain a three-frequency Doppler integration value, determining an epoch pseudo-range variable according to the three-frequency Doppler integration value, determining the epoch carrier phase variable according to the frequency carrier phase observation values, determining two groups of optimal three-frequency carrier phase combination coefficients according to the combination observation wavelength, the ionospheric delay coefficient, and the root mean square error of the pseudo-range phase combination cycle slip detection variable, determining a three-frequency STPIR slip detection variable and a three-frequency STPIR cycle slip detection threshold, and constructing three-frequency cycle slip solution equations according to the two groups of optimal three-frequency carrier phase combination coefficients, and obtaining a cycle slip value at a single frequency by solving the three-frequency cycle slip solution equations.

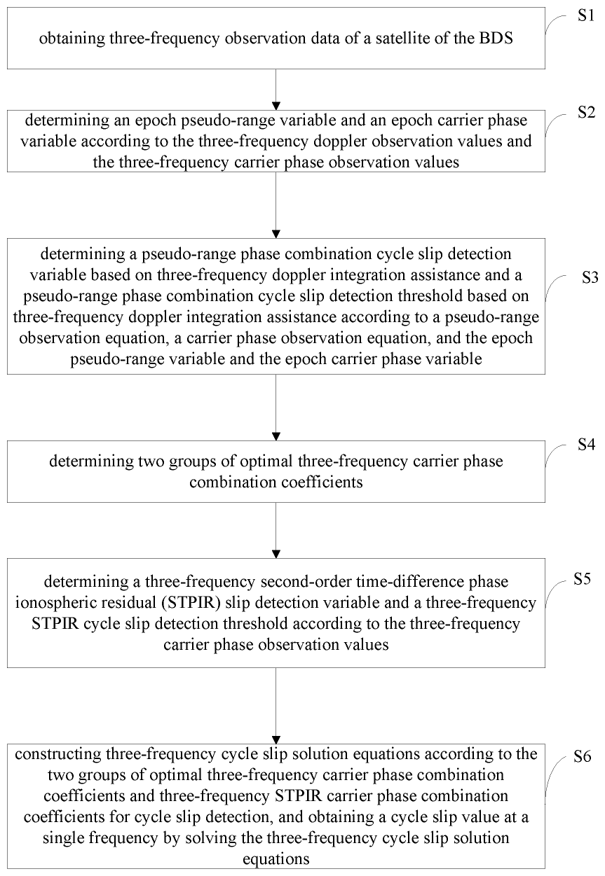

### TECHNICAL FIELD

The present disclosure relates to the technical field of cycle slip detection in satellite positioning, and in particularly, to a three-frequency cycle slip detection method of a BeiDou navigation satellite system (BDS) based on Doppler integration assistance.

### DESCRIPTION OF RELATED ART

With the completion of Beidou-3, the Beidou Navigation Satellite System (BDS) plays an increasingly important role in social production and construction. Users can use observation data from a multi-frequency BDS satellite for high-precision positioning. In a process of data processing, detection and repair of a cycle slip is one of keys to ensure accuracy of the positioning. A high-order time-difference method of traditional cycle slip detection methods amplifies the influence of an observation noise while making difference, and cannot detect a small cycle slip. A cycle slip detection accuracy of a polynomial fitting method depends on a fitting coefficient, and a cycle slip detection accuracy of data with a low sampling rate decreases with the decrease of sampling rate. A Melbourne-Wbbena (MW) combined method and an ionospheric residual method each have blind spots for cycle slip detection thereof. A pseudo-range phase combination method is suitable for three-frequency cycle slip detection, however, an accuracy of the three-frequency cycle slip detection is greatly affected by a pseudo-range observation noise. A second-order time-difference ionospheric residual (STPIR) method further weakens the influence of ionospheric change on cycle slip detection by making a second-order time-difference on cycle slip detection of ionospheric residual based on epoch.

For the above methods, a cycle slip detection variable is constructed based on a pseudo-range and a carrier phase observation value for performing cycle slip detection. Besides, a Doppler integration method is commonly used for single frequency cycle slip detection, but has a low accuracy of cycle slip detection for low sampling rate data. When using the Doppler integration method to detect cycle slip, the accuracy of cycle slip detection depends on an accuracy of Doppler observation and a data sampling rate. Although the accuracy of the Doppler observation value is much higher than that of a pseudo-range observation value, with the increase of a sampling interval, the error of the Doppler integration method increases, as such, the accuracy of cycle slip detection is decreased, and detection requirements of the small cycle slip cannot be met.

Based on the above technical problems, the present disclosure provides a Doppler-integration-assisted cycle slip detection combination method based on three-frequency Doppler and carrier phase observation data, so as to weaken the influence of Doppler integration error on cycle slip detection accuracy and thus improve the cycle slip detection ability of a Doppler observation value to observation data with a low sampling rate.

### SUMMARY

To achieve the above objectives, an embodiment of the present disclosure provides a three-frequency cycle slip detection method of a BeiDou navigation satellite system (BDS) based on Doppler integration assistance, which may include:
step 1, obtaining three-frequency observation data of a satellite of the BDS, including: obtaining an observation value file from a receiver of the satellite, and selecting three-frequency Doppler observation values and three-frequency carrier phase observation values corresponding to three frequencies from the observation value file;
step 2, determining an epoch pseudo-range variable and an epoch carrier phase variable according to the three-frequency Doppler observation values and the three-frequency carrier phase observation values;
step 3, determining a pseudo-range phase combination cycle slip detection variable based on three-frequency Doppler integration assistance and a pseudo-range phase combination cycle slip detection threshold based on three-frequency Doppler integration assistance according to a pseudo-range observation equation, a carrier phase observation equation, and the epoch pseudo-range variable and the epoch carrier phase variable;
step 4, determining two groups of optimal three-frequency carrier phase combination coefficients;
step 5, determining a three-frequency second-order time-difference phase ionospheric residual (STPIR) slip detection variable and a three-frequency STPIR cycle slip detection threshold according to the three-frequency carrier phase observation values; and
step 6, constructing three-frequency cycle slip solution equations for cycle slip detection according to the two groups of optimal three-frequency carrier phase combination coefficients and three-frequency STPIR carrier phase combination coefficients, and obtaining a cycle slip value at a single frequency by solving the three-frequency cycle slip solution equations.

In a further embodiment, the determining the epoch pseudo-range variable and the epoch carrier phase variable according to the three-frequency Doppler observation values and the three-frequency carrier phase observation values may include:
step 2-1, performing an epoch integration on the three-frequency Doppler observation values according to a formula (1), to obtain a three-frequency Doppler integration value:

$$Δ {φ}_{D} = - {\int }_{{t}_{n}}^{{t}_{n + 1}} D \cdot dt = - \frac{{D}_{n + 1} - {D}_{n}}{2} Δ t , \qquad ( 1 )$$

where Δφ_{D} represents the three-frequency Doppler integration value, t represents an observation time, n represents an epoch number, tₙ and tₙ₋₁ represent times respectively corresponding to an n-th epoch and an (n-1)-th epoch, D represents a three-frequency Doppler observation value, and Δt represents a sampling interval;
step 2-2, determining the epoch pseudo-range variable according to the three-frequency Doppler integration value using a formula (2):

$$Δ P = λ Δ {φ}_{D} = - λ \frac{{D}_{n + 1} - {D}_{n}}{2} Δ t , \qquad ( 2 )$$

where ΔP represents the epoch pseudo-range variable, and λ represents a wavelength of a corresponding one frequency of the three frequencies; and
step 2-3, determining the epoch carrier phase variable according to the three-frequency carrier phase observation values using a formula (3):

Δφ=φₙ₊₁−φₙ (3)

where Δφ represents the epoch carrier phase variable, and φ represents the three-frequency carrier phase observation value corresponding to the corresponding one frequency of the three frequencies.

In a further embodiment, the determining the pseudo-range phase combination cycle slip detection variable based on three-frequency Doppler integration assistance and the pseudo-range phase combination cycle slip detection threshold based on three-frequency Doppler integration assistance according to the pseudo-range observation equation, the carrier phase observation equation, and the epoch pseudo-range variable and the epoch carrier phase variable may include:
step 3-1, constructing the pseudo-range observation equation and the carrier phase observation equation as formulas (4) and (5) respectively:

P_{abc}=ρ+l_{abc}I₁+d_{abc}+m_{abc}+ε_{abc} (4)

λᵢⱼₖφᵢⱼₖ=ρ+lᵢⱼₖI1+dᵢⱼₖ+mᵢⱼₖ+λᵢⱼₖ Nᵢⱼₖ+εᵢⱼₖ, (5)

where P_{abc}=aP₁30 bP₂+cP₃ represents an observation variable of a three-frequency pseudo-range combination; φᵢⱼₖ=iφ₁+jφ₂+kφ₃ represents an observation variable of a three-frequency carrier phase combination; P₁, P₂, and P₃ respectively represent pseudo-range observation values corresponding to the three frequencies f₁, f₂, and f₃; a, b, c∈R; a, b, and c represent three-frequency pseudo-range combination coefficients; a+b+c=1; i, j, k∈Z, and i, j, and k represent three-frequency carrier phase combination coefficients; ρ represents a geometric distance between stations and satellites affected by clock error and tropospheric delay;

$${l}_{abc} = a + {b ( \frac{{λ}_{2}}{{λ}_{1}} )}^{2} + {c ( \frac{{λ}_{3}}{{λ}_{1}} )}^{2}$$

represents an ionospheric residual coefficient of the three-frequency pseudo-range combination;

$${l}_{ijk} = \frac{{λ}_{ijk}}{{λ}_{1}} ( i + j \frac{{λ}_{2}}{{λ}_{1}} + k \frac{{λ}_{3}}{{λ}_{1}} )$$

represents an ionospheric residual coefficient of the three-frequency carrier phase combination; I₁ represents an ionospheric delay term corresponding to the frequency f₁; d_{abc} and dᵢⱼₖ respectively represent a hardware delay term of the observation variable of the three-frequency pseudo-range combination and a hardware delay term of the observation variable of the three-frequency carrier phase combination; m_{abc} and mᵢⱼₖ respectively represent a multipath error of the observation variable of the three-frequency pseudo-range combination and a multipath error of the observation variable of the three-frequency carrier phase combination; ε_{abc} and εᵢⱼₖ respectively represent an observation noise of the observation variable of the three-frequency pseudo-range combination and an observation noise of the observation variable of the three-frequency carrier phase combination;

$${λ}_{ijk} = \frac{c}{i \cdot {f}_{1} + j \cdot {f}_{2} + k \cdot {f}_{3}}$$

represents a combination observation wavelength; Nᵢⱼₖ=iN₁+jN₂+kN₃ represents an integer ambiguity of the observation variable of the three-frequency carrier phase combination; and N₁, N₂, and N₃ represent integer ambiguities corresponding respectively to the three frequencies f₁, f₂, and f₃;
step 3-2, determining the integer ambiguity of the observation variable of the three-frequency carrier phase combination according to the pseudo-range observation equation and the carrier phase observation equation using a formula (6):

$${N}_{ijk} = {φ}_{ijk} - \frac{{P}_{abc}}{{λ}_{ijk}} + \frac{{l}_{ijk} + {l}_{abc}}{{λ}_{ijk}} {I}_{1} - \frac{{m}_{ijk} - {m}_{abc} + {d}_{ijk} - {d}_{abc}}{{λ}_{ijk}} - \frac{{ε}_{ijk} - {ε}_{abc}}{{λ}_{ijk}} ; \qquad ( 6 )$$

step 3-3, performing epoch difference on the formula (6), substituting the epoch pseudo-range variable ΔP in the formula (2) and the epoch carrier phase variable Δφ in the formula (3) into the formula (6) and calculating, and ignoring a hardware delay and a multipath effect of the receiver, and thereby obtaining an initial pseudo-range phase combination cycle slip detection variable based on three-frequency Doppler integration assistance expressed as a formula (7):

$$Δ {N}_{ijk} = Δ {φ}_{ijk} - \frac{Δ {P}_{abc}}{{λ}_{ijk}} + \frac{{l}_{ijk} + {l}_{abc}}{{λ}_{ijk}} Δ {I}_{1} - \frac{Δ {ε}_{ijk} - Δ {ε}_{abc}}{{λ}_{ijk}} , \qquad ( 7 )$$

where ΔNᵢⱼₖ represents the initial pseudo-range phase combination cycle slip detection variable based on three-frequency Doppler integration assistance; Δφᵢⱼₖ=iΔφ₁+jΔφ₂+kΔφ₃ represents an epoch carrier phase combination variable; ΔP_{abc}=aΔP₁+bΔP₂+cΔP₃ represents an epoch pseudo-range combination variable; ΔI₁ represents an epoch ionospheric delay variation corresponding to the frequency f₁, Δεᵢⱼₖ and Δε_{abc} respectively represent an epoch variation of the observation noise of the observation variable of the three-frequency carrier phase combination and an epoch variation of the observation noise of the observation variable of the three-frequency pseudo-range combination; in a situation that an ionosphere doesn't change much, the epoch ionospheric delay variation ΔI₁, the epoch variation Δεᵢⱼₖ of the observation noise of the observation variable of the three-frequency carrier phase combination and the epoch variation Δε_{abc} of the observation noise of the observation variable of the three-frequency pseudo-range combination in the formula (7) are capable of being ignored, and thus a final pseudo-range phase combination cycle slip detection variable based on three-frequency Doppler integration assistance is obtained expressed as a formula (8):

$$Δ {\hat{N}}_{ijk} = Δ {φ}_{ijk} - \frac{Δ {P}_{abc}}{{λ}_{ijk}} , \qquad ( 8 )$$

where Δ\hat{N}ᵢⱼₖ represents the final pseudo-range phase combination cycle slip detection variable based on three-frequency Doppler integration assistance, in which the epoch ionospheric delay variation ΔI₁, the epoch variation Δεᵢⱼₖ of the observation noise of the observation variable of the three-frequency carrier phase combination and the epoch variation Δε_{abc} of the observation noise of the observation variable of the three-frequency pseudo-range combination are ignored; and
step 3-4, determining a root mean square error of the pseudo-range phase combination cycle slip detection variable based on three-frequency Doppler integration assistance according to the three-frequency pseudo-range combination coefficients and the three-frequency carrier phase combination coefficients using a formula (9):

σ_{Δ\hat{N}}=\sqrt{2}\sqrt{(i²+j²+k²)σ_{φ}²+(a²+b²+c²)(Δt)²σ_{D}²/4λᵢⱼₖ²}, (9)

where σ_{Δ\hat{N}} represents the root mean square error of the pseudo-range phase combination cycle slip detection variable based on three-frequency Doppler integration assistance, σ_{φ} represents an accuracy of the three-frequency carrier phase observation value, σ_{D} represents an accuracy of the three-frequency Doppler observation value, σ_{φ}=0.01 cycle, σ_{D}=0.03 m, and three times of the root mean square error of the pseudo-range phase combination cycle slip detection variable based on three-frequency Doppler integration assistance is taken as the pseudo-range phase combination cycle slip detection threshold based on three-frequency Doppler integration assistance.

In a further embodiment, the determining two groups of optimal three-frequency carrier phase combination coefficients may include:
step 4-1, determining an ionospheric delay coefficient of the pseudo-range phase combination cycle slip detection variable based on three-frequency Doppler integration assistance using a formula (10):

$$β = \frac{{l}_{ijk} + {l}_{abc}}{{λ}_{ijk}} = \frac{( 1 + {l}_{abc} )}{{λ}_{1}} [ i + j \frac{{λ}_{2}^{2} + {λ}_{1}^{2} {l}_{abc}}{{λ}_{1} {λ}_{2} + {λ}_{1} {λ}_{2} {l}_{abc}} + k \frac{{λ}_{3}^{2} + {λ}_{1}^{2} {l}_{abc}}{{λ}_{1} {λ}_{3} + {λ}_{1} {λ}_{3} {l}_{abc}} ] , \qquad ( 10 )$$

where β represents the ionospheric delay coefficient of the pseudo-range phase combination cycle slip detection variable based on three-frequency Doppler integration assistance;
step 4-2, determining a combination coefficient selection condition according to the combination observation wavelength, the ionospheric delay coefficient, and the root mean square error of the pseudo-range phase combination cycle slip detection variable based on three-frequency Doppler integration assistance, and the combination coefficient selection condition may include:
(1) the combination observation wavelength λᵢⱼₖ is longer,
(2) the ionospheric delay coefficient

$$\frac{{l}_{ijk} + {l}_{abc}}{{λ}_{ijk}}$$

is smaller, and
(3) the root mean square error σ_{Δ\hat{N}} of the pseudo-range phase combination cycle slip detection variable based on three-frequency Doppler integration assistance is smaller; and
step 4-3, determining a search interval of three-frequency three-frequency carrier phase combination coefficients, and searching out, according to the search interval of three-frequency carrier phase combination coefficients and the combination coefficient selection condition, the two groups of optimal three-frequency carrier phase combination coefficients meeting the combination coefficient selection condition, where a sum of one group of the two groups of optimal three-frequency carrier phase combination coefficients is not equal to zero.

In a further embodiment, the determining the three-frequency STPIR slip detection variable and the three-frequency STPIR cycle slip detection threshold according to the three-frequency carrier phase observation values may include:
step 5-1, determining an observation variable of a three-frequency ionospheric residual combination according to the three-frequency STPIR carrier phase combination coefficients (1, 1, −2) using a formula (11):

$${φ}_{PIR} = {φ}_{1} + \frac{{λ}_{2}}{{λ}_{1}} {φ}_{2} - 2 \frac{{λ}_{3}}{{λ}_{1}} {φ}_{3} = {N}_{1} + \frac{{λ}_{2}}{{λ}_{1}} {N}_{2} - 2 \frac{{λ}_{3}}{{λ}_{1}} {N}_{3} + {I}_{123} , \qquad ( 11 )$$

where φ_{PIR} represents the observation variable of the three-frequency ionospheric residual combination, and

$${I}_{123} = ( 2 \frac{{λ}_{3}}{{λ}_{1}} - \frac{{λ}_{2}}{{λ}_{1}} - 1 ) \frac{I}{{λ}_{1}}$$

represents a delay of the three-frequency ionospheric residual combination;
step 5-2, performing epoch difference on the formula (11) to obtain a cycle slip detection variable of the three-frequency ionospheric residual combination expressed as a formula (12):

$$Δ {φ}_{PIR} ( n ) = {φ}_{PIR} ( n ) - {φ}_{PIR} ( n - 1 ) = [ Δ {N}_{1} + \frac{{λ}_{2}}{{λ}_{1}} Δ {N}_{2} - 2 \frac{{λ}_{2}}{{λ}_{1}} Δ {N}_{3} ] ( n ) + Δ {I}_{123} ( n ) , \qquad ( 12 )$$

where Δφ_{PIR} represents the cycle slip detection variable of the three-frequency ionospheric residual combination; ΔN₁, ΔN₂ and ΔN, and represent cycle slip values respectively corresponding to the three frequencies f₁, f₂, and f₃; ΔI₁₂₃=I₁₂₃(n)−I₁₂₃(n−1) represents an epoch ionospheric residual value;
step 5-3, performing epoch second-order time-difference on the cycle slip detection variable of the three-frequency ionospheric residual combination using a formula (13), to obtain the three-frequency STPIR cycle slip detection variable:

$$Δ {φ}_{STPIR} ( n ) = {φ}_{PIR} ( n ) - 2 {φ}_{PIR} ( n - 1 ) + {φ}_{PIR} ( n - 2 ) = \qquad ( 13 )$$

$$[ Δ {N}_{1} + \frac{{λ}_{2}}{{λ}_{1}} Δ {N}_{2} - 2 \frac{{λ}_{2}}{{λ}_{1}} Δ {N}_{3} ] ( n ) - [ Δ {N}_{1} + \frac{{λ}_{2}}{{λ}_{1}} Δ {N}_{2} - 2 \frac{{λ}_{2}}{{λ}_{1}} Δ {N}_{3} ] ( n - 1 ) + Δ I ( n ) ,$$

where Δφ_{STPIR} represents the three-frequency STPIR cycle slip detection variable, and ΔI(n)=I₁₂₃(n)−2I₁₂₃(n−1)+I₁₂₃(n−2) represents an ionospheric residual second-order term; and
step 5-4, determining a root mean square error of the three-frequency STPIR cycle slip detection variable, and determining the three-frequency STPIR cycle slip detection threshold according to the root mean square error of the three-frequency STPIR cycle slip detection variable, where the root mean square error of the three-frequency STPIR cycle slip detection variable is determined according to a formula (14):

$${σ}_{STPIR} = 2 \sqrt{{σ}_{φ}^{2} + {( \frac{{λ}_{2}}{{λ}_{1}} )}^{2} {σ}_{φ}^{2} + 4 {( \frac{{λ}_{3}}{{λ}_{1}} )}^{2} {σ}_{φ}^{2}} \approx 5.988 {σ}_{φ} , \qquad ( 14 )$$

where σ_{STPIR} represents the root mean square error of the three-frequency STPIR cycle slip detection variable, three times of the root mean square error of the three-frequency STPIR cycle slip detection variable is taken as the three-frequency STPIR cycle slip detection threshold, and in a situation that the three-frequency STPIR cycle slip detection variable is beyond the three-frequency STPIR cycle slip detection threshold, it is considered that a cycle slip occurred.

In an embodiment, the three-frequency cycle slip solution equations are expressed as a formula (15):

$$\{ \begin{matrix}Δ {\hat{N}}_{{i}_{1} , {j}_{1} , {k}_{1}} = {i}_{1} Δ {N}_{1} + {j}_{1} Δ {N}_{2} + {k}_{1} Δ {N}_{3} \\ Δ {\hat{N}}_{{i}_{2} , {j}_{2} , {k}_{2}} = {i}_{2} Δ {N}_{1} + {j}_{2} Δ {N}_{2} + {k}_{2} Δ {N}_{3} \\ Δ {φ}_{STPIR} = Δ {N}_{1} + \frac{{λ}_{2}}{{λ}_{1}} Δ {N}_{2} - 2 \frac{{λ}_{3}}{{λ}_{1}} Δ {N}_{3}\end{matrix} , \qquad ( 15 )$$

where (i₁, j₁, k₁) and (i₂, j₂, k₂) are two groups of three-frequency carrier phase combination coefficients.

Compared with the related arts, the three-frequency cycle slip detection method of a BDS based on Doppler integration assistance of the present disclosure has at least following beneficial effects.

Firstly, the present disclosure only needs to use three-frequency Doppler and carrier phase observation data for cycle slip detection, which weakens the influence of an Doppler integral error on cycle slip detection at a low sampling rate and improves the accuracy of the cycle slip detection.

Secondly, the present disclosure makes up a blind spot of cycle slip detection of a related method, and can effectively detect cycle slip of three-frequency combination for more than one cycle, providing a good cycle slip detection method for BDS three-frequency data.

### BRIEF DESCRIPTION OF THE DRAWING

The FIGURE illustrates a flow chart of a three-frequency cycle slip detection method of a BDS based on Doppler integration assistance according to an embodiment of the present disclosure.

### DETAILED DESCRIPTION OF EMBODIMENTS

According to steps shown in the FIGURE, a three-frequency cycle slip detection method of a BDS based on Doppler integration assistance of the present disclosure will be described in detail hereinafter.

In step 1, three-frequency observation data of a satellite of the BDS is obtained as , including: obtaining an observation value file from a receiver of the satellite, and selecting the three-frequency observation data of the satellite of the BDS corresponding to the three frequencies from the observation value file, where the three-frequency observation data of the satellite of the BDS includes three-frequency Doppler observation values and three-frequency carrier phase observation values, and the three frequencies include: f₁=1575.42 MHz, f₂=1176.45 MHz, and f₃=1268.52 MHz.

In step 2, an epoch pseudo-range variable and an epoch carrier phase variable are determined according to the three-frequency Doppler observation values and the three-frequency carrier phase observation values, which includes steps 2-1, 2-2 and 2-3.

In the step 2-1, an epoch integration is performed on the three-frequency Doppler observation values according to a formula (1), to obtain a three-frequency Doppler integration value (also referred to as an epoch carrier phase variable determined based on the three-frequency Doppler observation values):

$$Δ {φ}_{D} = - {\int }_{{t}_{n}}^{{t}_{n + 1}} D \cdot dt = - \frac{{D}_{n + 1} - {D}_{n}}{2} Δ t , \qquad ( 1 )$$

where Δφ_{D} represents the three-frequency Doppler integration value, t represents an observation time, n represents an epoch number, to tₙ and tₙ₋₁ represent times respectively corresponding to an n-th epoch and an (n−1)-th epoch, D represents a three-frequency Doppler observation value, and Δₜ represents a sampling interval.

In the step 2-2, the epoch pseudo-range variable is determined according to the three-frequency Doppler integration value using a formula (2):

$$Δ P = {λΔφ}_{D} = - λ \frac{{D}_{n + 1} - {D}_{n}}{2} Δ t , \qquad ( 2 )$$

where ΔP represents the epoch pseudo-range variable, and λ represents a wavelength of a corresponding one frequency of the three frequencies.

In the step 2-3, the epoch carrier phase variable is determined according to the three-frequency carrier phase observation values using a formula (3):

Δφ=φₙ₊₁−φₙ, (3)

where Δφ represents the epoch carrier phase variable (also referred to as the epoch carrier phase variable determined based on the three-frequency carrier phase observation value), and φ represents the three-frequency carrier phase observation value corresponding to the corresponding one frequency of the three frequencies.

In step 3, a pseudo-range phase combination cycle slip detection variable based on three-frequency Doppler integration assistance and a pseudo-range phase combination cycle slip detection threshold based on three-frequency Doppler integration assistance are determined, which includes steps 3-1, 3-2, 3-3 and 3-4.

In the step 3-1, a pseudo-range observation equation and a carrier phase observation equation are constructed respectively as formulas (4) and (5):

P_{abc}=ρ+l_{abc}I₁+d_{abc}+m_{abc}+ε_{abc} (4)

λᵢⱼₖφᵢⱼₖ=ρ+lᵢⱼₖI₁+dᵢⱼₖ+mᵢⱼₖ+λᵢⱼₖNᵢⱼₖ+εᵢⱼₖ, (5)

where P_{abc}=aP₁+bP₂+cP₃ represents an observation variable of a three-frequency pseudo-range combination; φᵢⱼₖ=iφ₁+jφ₂+kφ₃ represents an observation variable of a three-frequency carrier phase combination; P₁, P₂, and P₃ respectively represent pseudo-range observation values corresponding to the three frequencies f₁, f₂, and f₃; a, b, c∈R ; a, b, and c represent three-frequency pseudo-range combination coefficients; a+b+c=1; i, j, k∈Z, and i, j, and k represent three-frequency carrier phase combination coefficients. ρ represents a geometric distance between stations and satellites affected by clock error and tropospheric delay;

$${l}_{abc} = a + {b ( \frac{{λ}_{2}}{{λ}_{1}} )}^{2} + {c ( \frac{{λ}_{3}}{{λ}_{1}} )}^{2}$$

represents an ionospheric residual coefficient of the three-frequency pseudo-range combination;

$${l}_{ijk} = \frac{{λ}_{ijk}}{{λ}_{1}} ( i + j \frac{{λ}_{2}}{{λ}_{1}} + k \frac{{λ}_{3}}{{λ}_{1}} )$$

represents an ionospheric residual coefficient of the three-frequency carrier phase combination; I₁ represents an ionospheric delay term corresponding to the frequency f₁; d_{abc} and dᵢⱼₖ respectively represent a hardware delay term of the observation variable of the three-frequency pseudo-range combination and a hardware delay term of the observation variable of the three-frequency carrier phase combination; m_{abc} and mᵢⱼₖ respectively represent a multipath error of the observation variable of the three-frequency pseudo-range combination and a multipath error of the observation variable of the three-frequency carrier phase combination; ε_{abc} and εᵢⱼₖ respectively represent an observation noise of the observation variable of the three-frequency pseudo-range combination the observation variable of the three-frequency carrier phase combination;

$${λ}_{ijk} = \frac{c}{i \cdot {f}_{1} + j \cdot {f}_{2} + k \cdot {f}_{3}}$$

represents a combination observation wavelength; Nᵢⱼₖ=iN₁+jN₂+kN₃ represents an integer ambiguity of the observation variable of the three-frequency carrier phase combination; and N₁, N₂, and N₃ represent integer ambiguities corresponding respectively to the three frequencies f₁, f₂, and f₃.

In the step 3-2, the integer ambiguity of the observation variable of the three-frequency carrier phase combination is determined according to the pseudo-range observation equation and the carrier phase observation equation using a formula (6):

$${N}_{ijk} = {φ}_{ijk} - \frac{{P}_{abc}}{{λ}_{ijk}} + \frac{{l}_{ijk} + {l}_{abc}}{{λ}_{ijk}} {I}_{1} - \frac{\begin{matrix}{m}_{ijk} - {m}_{abc} + \\ {d}_{ijk} - {d}_{abc}\end{matrix}}{{λ}_{ijk}} - \frac{{ε}_{ijk} - {ε}_{abc}}{{λ}_{ijk}} . \qquad ( 6 )$$

In the step 3-3, an initial pseudo-range phase combination cycle slip detection variable based on three-frequency Doppler integration assistance is determined, through performing epoch difference on the formula (6), substituting the epoch pseudo-range variable ΔP in the formula (2) and the epoch carrier phase variable Δφ in the formula (3) into the formula (6) and calculating, and ignoring a hardware delay and a multipath effect of the receiver, and thereby obtaining the initial pseudo-range phase combination cycle slip detection variable based on three-frequency Doppler integration assistance expressed as a formula (7):

$$Δ {N}_{ijk} = {Δφ}_{ijk} - \frac{Δ {P}_{abc}}{{λ}_{ijk}} + \frac{{l}_{ijk} + {l}_{abc}}{{λ}_{ijk}} Δ {I}_{1} - \frac{{Δε}_{ijk} - {Δε}_{abc}}{{λ}_{ijk}} , \qquad ( 7 )$$

where ΔNᵢⱼₖ represents the initial pseudo-range phase combination cycle slip detection variable based on three-frequency Doppler integration assistance; Δφᵢⱼₖ=iΔφ₁+jΔφ₂+kΔφ₃ represents an epoch carrier phase combination variable; ΔP_{abc}=aΔP₁+bΔP₂+cΔP₃ represents an epoch pseudo-range combination variable; ΔI₁ represents an epoch ionospheric delay variation corresponding to the frequency f₁, Δεᵢⱼₖ and Δε_{abc} respectively represent an epoch variation of the observation noise of the observation variable of the three-frequency carrier phase combination and an epoch variation of the observation noise of the observation variable of the three-frequency pseudo-range combination; in a situation that an ionosphere doesn't change much, the epoch ionospheric delay variation ΔI₁, the epoch variation Δεᵢⱼₖ of the observation noise of the observation variable of the three-frequency carrier phase combination and the epoch variation Δε_{abc} of the observation noise of the observation variable of the three-frequency pseudo-range combination in the formula (7) are capable of being ignored, and thus a final pseudo-range phase combination cycle slip detection variable based on three-frequency Doppler integration assistance is obtained expressed as a formula (8):

$$Δ {\hat{N}}_{ijk} = {Δφ}_{ijk} - \frac{Δ {P}_{abc}}{{λ}_{ijk}} , \qquad ( 8 )$$

where Δ\hat{N}ᵢⱼₖ represents the final pseudo-range phase combination cycle slip detection variable based on three-frequency Doppler integration assistance, in which the epoch ionospheric delay variation ΔI₁, the epoch variation Δεᵢⱼₖ of the observation noise of the observation variable of the three-frequency carrier phase combination and the epoch variation Δε_{abc} of the observation noise of the observation variable of the three-frequency pseudo-range combination are ignored.

In the step 3-4, a root mean square error of the pseudo-range phase combination cycle slip detection variable based on three-frequency Doppler integration assistance is determined according to the three-frequency pseudo-range combination coefficients and the three-frequency carrier phase combination coefficients using a formula (9):

σ_{Δ\hat{N}}=\sqrt{2}\sqrt{(i²+j²+k²)σ_{φ}²+(a²+b²+c²)(Δt)²σ_{D}²/4λᵢⱼₖ²}, (9)

where σ_{Δ\hat{N}} represents the root mean square error of the pseudo-range phase combination cycle slip detection variable based on three-frequency Doppler integration assistance, σ_{φ} represents an accuracy of the three-frequency carrier phase observation value, σ_{D} represents an accuracy of the three-frequency Doppler observation value, σ_{φ}=0.01 cycle, σ_{D}=0.03 m, and three times of the root mean square error of the pseudo-range phase combination cycle slip detection variable based on three-frequency Doppler integration assistance is taken as the pseudo-range phase combination cycle slip detection threshold based on three-frequency Doppler integration assistance.

In step 4, two groups of optimal three-frequency carrier phase combination coefficients are determined, which includes steps 4-1, 4-2, and 4-3.

In the step 4-1, an ionospheric delay coefficient of the pseudo-range phase combination cycle slip detection variable based on three-frequency Doppler integration assistance is determined using a formula (10):

$$β = \frac{{l}_{ijk} + {l}_{abc}}{{λ}_{ijk}} = \frac{( 1 + {l}_{abc} )}{{λ}_{1}} [ i + j \frac{{λ}_{2}^{2} + {λ}_{1}^{2} {l}_{abc}}{\begin{matrix}{λ}_{1} {λ}_{2} + \\ {λ}_{1} {λ}_{2} {l}_{abc}\end{matrix}} + k \frac{{λ}_{3}^{2} + {λ}_{1}^{2} {l}_{abc}}{\begin{matrix}{λ}_{1} {λ}_{3} + \\ {λ}_{1} {λ}_{3} {l}_{abc}\end{matrix}} ] , \qquad ( 10 )$$

where β represents the ionospheric delay coefficient of the pseudo-range phase combination cycle slip detection variable based on three-frequency Doppler integration assistance.

In the step 4-2, a combination coefficient selection condition is determined according to the combination observation wavelength, the ionospheric delay coefficient, and the root mean square error of the pseudo-range phase combination cycle slip detection variable based on three-frequency Doppler integration assistance, and the combination coefficient selection condition includes: (1) the combination observation wavelength λᵢⱼₖ is longer, (2) the ionospheric delay coefficient

$$\frac{{l}_{ijk} + {l}_{abc}}{{λ}_{ijk}}$$

is smaller, and (3) the root mean square error σ_{Δ\hat{N}} of the pseudo-range phase combination cycle slip detection variable based on three-frequency Doppler integration assistance is smaller.

In the step 4-3, the two groups of optimal three-frequency carrier phase combination coefficients are determined. Specifically, the three-frequency pseudo-range combination adopts an equal weight model, that is to say, a=b=c=⅓. The ionospheric residual coefficient of the three-frequency pseudo-range combination l_{abc}=1.445, the ionospheric delay coefficient is β=12.85×(i+0.989j+0.984k) . Based on the combination coefficient selection condition, a search interval of three-frequency carrier phase combination coefficients is determined as [−10, 10]. a searching condition including the combination observation wavelength being greater than 5 miles (m), |i+j+k|≤2 and σ_{66 \hat{N}}≤0.2 is used to search out the two groups of optimal three-frequency carrier phase combination coefficients meeting the searching condition. A sum of one of the two groups of optimal three-frequency carrier phase combination coefficients is not equal to zero, and thus the determined two groups of optimal three-frequency carrier phase combination coefficients are (1, 3, −4) and (−2, 7, −4). Based on the two groups of three-frequency carrier phase combination coefficients, two pseudo-range phase combination cycle slip detection thresholds are determined, the pseudo-range phase combination cycle slip detection threshold 0.22 cycle corresponding to the three-frequency carrier phase combination coefficients (1, 3, −4) and the pseudo-range phase combination cycle slip detection threshold 0.35 cycle corresponding to the three-frequency carrier phase combination coefficients (-2, 7, −4).

In step 5, a three-frequency second-order time-difference phase ionospheric residual (STPIR) slip detection variable and a three-frequency STPIR cycle slip detection threshold are determined according to the three-frequency carrier phase observation values, which includes steps 5-1, 5-2, 5-3, and 5-4.

In the step 5-1, an observation variable of a three-frequency ionospheric residual combination is determined according to the three-frequency STPIR carrier phase combination coefficients (1, 1, −2) using a formula (11):

$${φ}_{PIR} = {φ}_{1} + \frac{{λ}_{2}}{{λ}_{1}} {φ}_{2} - 2 \frac{ {λ}_{3}}{{λ}_{1}} {φ}_{3} = {N}_{1} + \frac{{λ}_{2}}{{λ}_{1}} {N}_{2} - 2 \frac{{λ}_{3}}{{λ}_{1}} {N}_{3} + {I}_{123} , \qquad ( 11 )$$

where φ_{PIR} represents the observation variable of the three-frequency ionospheric residual combination, and

$${I}_{123} = ( 2 \frac{{λ}_{3}}{{λ}_{1}} - \frac{{λ}_{2}}{{λ}_{1}} - 1 ) \frac{I}{{λ}_{1}} = 1.483 I$$

represents a delay of the three-frequency ionospheric residual combination.

In the step 5-2, epoch difference is performed on the formula (11) to obtain a cycle slip detection variable of the three-frequency ionospheric residual combination expressed as a formula (12):

$${Δφ}_{PIR} ( n ) = {φ}_{PIR} ( n ) - {φ}_{PIR} ( n - 1 ) = [ Δ {N}_{1} + \frac{{λ}_{2}}{{λ}_{1}} Δ {N}_{2} - 2 \frac{{λ}_{2}}{{λ}_{1}} Δ {N}_{3} ] ( n ) + Δ {I}_{123} ( n ) , \qquad ( 12 )$$

where Δφ_{PIR} represents the cycle slip detection variable of the three-frequency ionospheric residual combination; ΔN₁, ΔN₂ and ΔN₃ represent cycle slip values respectively corresponding to the three frequencies f₁, f₂, and f₃; ΔI₁₂₃=I₁₂₃(n)−I₁₂₃(n−1) represents an epoch ionospheric residual value.

In the step 5-3, epoch second-order time-difference is performed on the cycle slip detection variable of the three-frequency ionospheric residual combination using a formula (13), to obtain the three-frequency STPIR cycle slip detection variable:

$${Δφ}_{STPIR} ( n ) = {φ}_{PIR} ( n ) - 2 {φ}_{PIR} ( n - 1 ) + {φ}_{PIR} ( n - 2 ) = [ Δ {N}_{1} + \frac{{λ}_{2}}{{λ}_{1}} Δ {N}_{2} - 2 \frac{{λ}_{2}}{{λ}_{1}} Δ {N}_{3} ] \text{} ( n ) - [ Δ {N}_{1} + \frac{{λ}_{2}}{{λ}_{1}} Δ {N}_{2} - 2 \frac{{λ}_{2}}{{λ}_{1}} Δ {N}_{3} ] ( n - 1 ) + Δ I ( n ) , \qquad ( 13 )$$

where Δφ_{STPIR} represents the three-frequency STPIR cycle slip detection variable, and ΔI(n)=I₁₂₃(n)−2I₁₂₃(n−1)+I₁₂₃(n−2) represents an ionospheric residual second-order term.

In the step 5-4, a root mean square error of the three-frequency STPIR cycle slip detection variable is determined, and the three-frequency STPIR cycle slip detection threshold is determined according to the root mean square error of the three-frequency STPIR cycle slip detection variable. The root mean square error of the three-frequency STPIR cycle slip detection variable is determined according to a formula (14):

$${σ}_{STPIR} = 2 \sqrt{{σ}_{φ}^{2} + {( \frac{{λ}_{2}}{{λ}_{1}} )}^{2} {σ}_{φ}^{2} + 4 {( \frac{{λ}_{3}}{{λ}_{1}} )}^{2} {σ}_{φ}^{2}} \approx 5.988 {σ}_{φ} , \qquad ( 14 )$$

where σ_{STPIR} represents the root mean square error of the three-frequency STPIR cycle slip detection variable, σ_{STPIR}≈0.06 cycle, Three times of the root mean square error of the three-frequency STPIR cycle slip detection variable is taken as the three-frequency STPIR cycle slip detection threshold, and thus the three-frequency STPIR cycle slip detection threshold is 0.18 cycle, the three-frequency STPIR cycle slip detection variable is greater than 0.18 cycle. If the three-frequency STPIR cycle slip detection variable is beyond the three-frequency STPIR cycle slip detection threshold, it is considered that a cycle slip occurred.

In step 6, three-frequency cycle slip solution equations are constructed according to the two groups of optimal three-frequency carrier phase combination coefficients, the three-frequency STPIR slip detection variable, and three-frequency STPIR carrier phase combination coefficients for cycle slip detection. A cycle slip value at a single frequency can be obtained by solving the three-frequency cycle slip solution equations.

The three-frequency cycle slip solution equations are expressed as a formula (15):

$$\{ \begin{matrix}Δ {\hat{N}}_{- 2 , 7 , - 4} = - 2 Δ {N}_{1} + 7 Δ {N}_{2} - 4 Δ {N}_{3} \\ Δ {\hat{N}}_{1 , 3 , - 4} = Δ {N}_{1} + 3 Δ {N}_{2} - 4 Δ {N}_{3} \\ {Δφ}_{STPIR} = Δ {N}_{1} + \frac{{λ}_{2}}{{λ}_{1}} Δ {N}_{2} - 2 \frac{{λ}_{3}}{{λ}_{1}} Δ {N}_{3}\end{matrix} . \qquad ( 15 )$$

The present disclosure provides a three-frequency cycle slip detection method of a BDS based on Doppler integration assistance, aiming at the problem of low cycle slip detection accuracy of a single-frequency Doppler observation value to a low-sampling rate data, the three-frequency cycle slip detection method of a BDS based on Doppler integration assistance is proposed based on BDS three-frequency data, which can effectively weaken the influence of a Doppler integration error on cycle slip detection at the low sampling rate, make up a blind spot of a related method, improve the accuracy of three-frequency cycle slip detection, and provide a foundation for high-precision positioning of the BDS.

The above are merely preferable embodiments of the present disclosure, and it is not intended to limit the present disclosure. Any modification, equivalent substitution, improvement, etc. made within the spirit and principle of the present disclosure should be included in the scope of protection of the present disclosure.

What is claimed is:

1. A three-frequency cycle slip detection method of a BeiDou navigation satellite system (BDS) based on Doppler integration assistance, comprising:
step 1, obtaining three-frequency observation data of a satellite of the BDS, comprising: obtaining an observation value file from a receiver of the satellite, and selecting three-frequency Doppler observation values and three-frequency carrier phase observation values corresponding to three frequencies from the observation value file;
step 2, determining an epoch pseudo-range variable and an epoch carrier phase variable according to the three-frequency Doppler observation values and the three-frequency carrier phase observation values;
step 3, determining a pseudo-range phase combination cycle slip detection variable based on three-frequency Doppler integration assistance and a pseudo-range phase combination cycle slip detection threshold based on three-frequency Doppler integration assistance according to a pseudo-range observation equation, a carrier phase observation equation, and the epoch pseudo-range variable and the epoch carrier phase variable;
step 4, determining two groups of optimal three-frequency carrier phase combination coefficients;
step 5, determining a three-frequency second-order time-difference phase ionospheric residual (STPIR) slip detection variable and a three-frequency STPIR cycle slip detection threshold according to the three-frequency carrier phase observation values; and
step 6, constructing three-frequency cycle slip solution equations according to the two groups of optimal three-frequency carrier phase combination coefficients and three-frequency STPIR carrier phase combination coefficients for cycle slip detection, and obtaining a cycle slip value at a single frequency by solving the three-frequency cycle slip solution equations.

2. The three-frequency cycle slip detection method of the BDS based on Doppler integration assistance according to claim 1, wherein the determining the epoch pseudo-range variable and the epoch carrier phase variable according to the three-frequency Doppler observation values and the three-frequency carrier phase observation values, comprises:
step 2-1, performing an epoch integration on the three-frequency Doppler observation values according to a formula (1), to obtain a three-frequency Doppler integration value:
$${Δφ}_{D} = - {\int }_{{t}_{n}}^{{t}_{n + 1}} D \cdot dt = - \frac{{D}_{n + 1} - {D}_{n}}{2} Δ t , \qquad ( 1 )$$
where Δφ_{D} represents the three-frequency Doppler integration value, t represents an observation time, n represents an epoch number, tₙ and tₙ₋₁ represent times respectively corresponding to an n-th epoch and an (n-1)-th epoch, D represents a three-frequency Doppler observation value, and Δt represents a sampling interval;
step 2-2, determining the epoch pseudo-range variable according to the three-frequency Doppler integration value using a formula (2):
$$Δ P = {λΔφ}_{D} = - λ \frac{{D}_{n + 1} - {D}_{n}}{2} Δ t , \qquad ( 2 )$$
where ΔP represents the epoch pseudo-range variable, and λ represents a wavelength of a corresponding one frequency of the three frequencies; and
step 2-3, determining the epoch carrier phase variable according to the three-frequency carrier phase observation values using a formula (3):
Δφ=φₙ₊₁−φₙ, (3)
where Δφ represents the epoch carrier phase variable, and φ represents the three-frequency carrier phase observation value corresponding to the corresponding one frequency of the three frequencies.

3. The three-frequency cycle slip detection method of the BDS based on Doppler integration assistance according to claim 2, wherein the determining the pseudo-range phase combination cycle slip detection variable based on three-frequency Doppler integration assistance and the pseudo-range phase combination cycle slip detection threshold based on three-frequency Doppler integration assistance according to the pseudo-range observation equation, the carrier phase observation equation, and the epoch pseudo-range variable and the epoch carrier phase variable, comprises:
step 3-1, constructing the pseudo-range observation equation and the carrier phase observation equation as formulas (4) and (5) respectively:
P_{abc}=ρ+l_{abc}I₁+d_{abc}+m_{abc}+ε_{abc} (4)
λᵢⱼₖφᵢⱼₖ=ρ+lᵢⱼₖI1+dᵢⱼₖ+mᵢⱼₖ+λᵢⱼₖ Nᵢⱼₖ+εᵢⱼₖ, (5)
where P_{abc}=aP₁30 bP₂+cP₃ represents an observation variable of a three-frequency pseudo-range combination; φᵢⱼₖ=iφ₁+jφ₂+kφ₃ represents an observation variable of a three-frequency carrier phase combination; P₁, P₂, and P₃ respectively represent pseudo-range observation values corresponding to the three frequencies f₁, f₂, and f₃; a, b, c∈R; a, b, and c represent three-frequency pseudo-range combination coefficients; a+b+c=1; i, j, k∈Z, and i, j, and k represent three-frequency carrier phase combination coefficients; ρ represents a geometric distance between stations and satellites affected by clock error and tropospheric delay;
$${l}_{abc} = a + {b ( \frac{{λ}_{2}}{{λ}_{1}} )}^{2} + {c ( \frac{{λ}_{3}}{{λ}_{1}} )}^{2}$$
represents an ionospheric residual coefficient of the three-frequency pseudo-range combination;
$${l}_{ijk} = \frac{{λ}_{ijk}}{{λ}_{1}} ( i + j \frac{{λ}_{2}}{{λ}_{1}} + k \frac{{λ}_{3}}{{λ}_{1}} )$$
represents an ionospheric residual coefficient of the three-frequency carrier phase combination; I₁ represents an ionospheric delay term corresponding to the frequency f₁; d_{abc} and dᵢⱼₖ respectively represent a hardware delay term of the observation variable of the three-frequency pseudo-range combination and a hardware delay term of the observation variable of the three-frequency carrier phase combination; m_{abc} and mᵢⱼₖ respectively represent a multipath error of the observation variable of the three-frequency pseudo-range combination and a multipath error of the observation variable of the three-frequency carrier phase combination; ε_{abc} and εᵢⱼₖ respectively represent an observation noise of the observation variable of the three-frequency pseudo-range combination and an observation noise of the observation variable of the three-frequency carrier phase combination;
$${λ}_{ijk} = \frac{c}{i \cdot {f}_{1} + j \cdot {f}_{2} + k \cdot {f}_{3}}$$
represents a combination observation wavelength; Nᵢⱼₖ=iN₁+jN₂+kN₃ represents an integer ambiguity of the observation variable of the three-frequency carrier phase combination; and N₁, N₂, and N₃ represent integer ambiguities corresponding respectively to the three frequencies f₁, f₂, and f₃;
step 3-2, determining the integer ambiguity of the observation variable of the three-frequency carrier phase combination according to the pseudo-range observation equation and the carrier phase observation equation using a formula (6):
$${N}_{ijk} = {φ}_{ijk} - \frac{{P}_{a b c}}{{λ}_{ijk}} + \frac{{l}_{ijk} + {l}_{a b c}}{{λ}_{ijk}} {I}_{1} - \frac{{m}_{ijk} - {m}_{a b c} + {d}_{ijk} - {d}_{a b c}}{{λ}_{ijk}} - \frac{{ε}_{ijk} - {ε}_{a b c}}{{λ}_{ijk}} ; \qquad ( 6 )$$
step 3-3, performing epoch difference on the formula (6), substituting the epoch pseudo-range variable ΔP in the formula (2) and the epoch carrier phase variable Δφ in the formula (3) into the formula (6) and calculating, and ignoring a hardware delay and a multipath effect of the receiver, and thereby obtaining an initial pseudo-range phase combination cycle slip detection variable based on three-frequency Doppler integration assistance expressed as a formula (7):
$$Δ {N}_{ijk} = {Δφ}_{ijk} - \frac{Δ {P}_{a b c}}{{λ}_{ijk}} + \frac{{l}_{ijk} + {l}_{a b c}}{{λ}_{ijk}} Δ {I}_{1} - \frac{{Δε}_{ijk} - {Δε}_{abc}}{{λ}_{ijk}} , \qquad ( 7 )$$
where ΔNᵢⱼₖ represents the initial pseudo-range phase combination cycle slip detection variable based on three-frequency Doppler integration assistance; Δφᵢⱼₖ=iΔφ₁+jΔφ₂+kΔφ₃ represents an epoch carrier phase combination variable; ΔP_{abc}=aΔP₁+bΔP₂+cΔP₃ represents an epoch pseudo-range combination variable; ΔI₁ represents an epoch ionospheric delay variation corresponding to the frequency f₁, Δεᵢⱼₖ and Δε_{abc} respectively represent an epoch variation of the observation noise of the observation variable of the three-frequency carrier phase combination and an epoch variation of the observation noise of the observation variable of the three-frequency pseudo-range combination; in a situation that an ionosphere doesn't change much, the epoch ionospheric delay variation ΔI₁, the epoch variation Δεᵢⱼₖ of the observation noise of the observation variable of the three-frequency carrier phase combination and the epoch variation Δε_{abc} of the observation noise of the observation variable of the three-frequency pseudo-range combination in the formula (7) are capable of being ignored, and thus a final pseudo-range phase combination cycle slip detection variable based on three-frequency Doppler integration assistance is obtained expressed as a formula (8):
$$Δ {\hat{N}}_{i j k} = {Δφ}_{i j k} - \frac{Δ {P}_{a b c}}{{λ}_{ijk}} , \qquad ( 8 )$$
where Δ\hat{N}ᵢⱼₖ represents the final pseudo-range phase combination cycle slip detection variable based on three-frequency Doppler integration assistance, in which the epoch ionospheric delay variation ΔI₁, the epoch variation Δεᵢⱼₖ of the observation noise of the observation variable of the three-frequency carrier phase combination and the epoch variation Δε_{abc} of the observation noise of the observation variable of the three-frequency pseudo-range combination are ignored; and
step 3-4, determining a root mean square error of the pseudo-range phase combination cycle slip detection variable based on three-frequency Doppler integration assistance according to the three-frequency pseudo-range combination coefficients and the three-frequency carrier phase combination coefficients using a formula (9):
σ_{Δ\hat{N}}=\sqrt{2}\sqrt{(i²+j²+k²)σ_{φ}²+(a²+b²+c²)(Δt)²σ_{D}²/4λᵢⱼₖ²}, (9)
where σ_{Δ\hat{N}} represents the root mean square error of the pseudo-range phase combination cycle slip detection variable based on three-frequency Doppler integration assistance, σ_{φ} represents an accuracy of the three-frequency carrier phase observation value, σ_{D} represents an accuracy of the three-frequency Doppler observation value, σ_{φ}=0.01 cycle, σ_{D}=0.03 m, and three times of the root mean square error of the pseudo-range phase combination cycle slip detection variable based on three-frequency Doppler integration assistance is taken as the pseudo-range phase combination cycle slip detection threshold based on three-frequency Doppler integration assistance.

4. The three-frequency cycle slip detection method of the BDS based on Doppler integration assistance according to claim 3, wherein the determining two groups of optimal three-frequency carrier phase combination coefficients, comprises:
step 4-1, determining an ionospheric delay coefficient of the pseudo-range phase combination cycle slip detection variable based on three-frequency Doppler integration assistance using a formula (10):
$$β = \frac{{l}_{ijk} + {l}_{a b c}}{{λ}_{ijk}} = \frac{( 1 + {l}_{a b c} )}{{λ}_{1}} [ i + j \frac{{λ}_{2}^{2} + {λ}_{1}^{2} {l}_{a b c}}{{λ}_{1} {λ}_{2} + {λ}_{1} {λ}_{2} {l}_{a b c}} + k \frac{{λ}_{3}^{2} + {λ}_{1}^{2} {l}_{a b c}}{{λ}_{1} {λ}_{3} + {λ}_{1} {λ}_{3} {l}_{a b c}} ] , \qquad ( 10 )$$
where β represents the ionospheric delay coefficient of the pseudo-range phase combination cycle slip detection variable based on three-frequency Doppler integration assistance;
step 4-2, determining a combination coefficient selection condition according to the combination observation wavelength, the ionospheric delay coefficient, and the root mean square error of the pseudo-range phase combination cycle slip detection variable based on three-frequency Doppler integration assistance, and the combination coefficient selection condition comprises:
(1) the combination observation wavelength λᵢⱼₖ is longer,
(2) the ionospheric delay coefficient
$$\frac{{l}_{ijk} + {l}_{abc}}{{λ}_{ijk}}$$
is smaller, and
(3) the root mean square error σ_{Δ\hat{N}} of the pseudo-range phase combination cycle slip detection variable based on three-frequency Doppler integration assistance is smaller; and
step 4-3, determining a search interval of three-frequency three-frequency carrier phase combination coefficients, and searching out, according to the search interval of three-frequency carrier phase combination coefficients and the combination coefficient selection condition, the two groups of optimal three-frequency carrier phase combination coefficients meeting the combination coefficient selection condition, wherein a sum of one group of the two groups of optimal three-frequency carrier phase combination coefficients is not equal to zero.

5. The three-frequency cycle slip detection method of the BDS based on Doppler integration assistance according to claim 1, wherein the determining the three-frequency STPIR slip detection variable and the three-frequency STPIR cycle slip detection threshold according to the three-frequency carrier phase observation values, comprises:
step 5-1, determining an observation variable of a three-frequency ionospheric residual combination according to the three-frequency STPIR carrier phase combination coefficients (1, 1, −2) using a formula (11):
$${φ}_{P I R} = {φ}_{1} + \frac{{λ}_{2}}{{λ}_{1}} {φ}_{2} - 2 \frac{{λ}_{3}}{{λ}_{1}} {φ}_{3} = {N}_{1} + \frac{{λ}_{2}}{{λ}_{1}} {N}_{2} - 2 \frac{{λ}_{3}}{{λ}_{1}} {N}_{3} + {I}_{123} , \qquad ( 11 )$$
where φ_{PIR} represents the observation variable of the three-frequency ionospheric residual combination, and
$${I}_{123} = ( 2 \frac{{λ}_{3}}{{λ}_{1}} - \frac{{λ}_{2}}{{λ}_{1}} - 1 ) \frac{I}{{λ}_{1}}$$
represents a delay of the three-frequency ionospheric residual combination;
step 5-2, performing epoch difference on the formula (11) to obtain a cycle slip detection variable of the three-frequency ionospheric residual combination expressed as a formula (12):
$${Δφ}_{P I R} ( n ) = {φ}_{P I R} ( n ) - {φ}_{P I R} ( n - 1 ) = [ Δ {N}_{1} + \frac{{λ}_{2}}{{λ}_{1}} Δ {N}_{2} - 2 \frac{{λ}_{2}}{{λ}_{1}} Δ {N}_{3} ] ( n ) + Δ {I}_{123} ( n ) , \qquad ( 12 )$$
where Δφ_{PIR} represents the cycle slip detection variable of the three-frequency ionospheric residual combination; ΔN₁, ΔN₂ and ΔN₃ represent cycle slip values respectively corresponding to the three frequencies f₁, f₂, and f₃; ΔI₁₂₃=I₁₂₃(n)−I₁₂₃ (n−1) represents an epoch ionospheric residual value;
step 5-3, performing epoch second-order time-difference on the cycle slip detection variable of the three-frequency ionospheric residual combination using a formula (13), to obtain the three-frequency STPIR cycle slip detection variable:
$${Δφ}_{STPIR} ( n ) = {φ}_{P I R} ( n ) - 2 {φ}_{P I R} ( n - 1 ) + {φ}_{PIR} ( n - 2 ) = [ Δ {N}_{1} + \frac{{λ}_{2}}{{λ}_{1}} Δ {N}_{2} - 2 \frac{{λ}_{2}}{{λ}_{1}} Δ {N}_{3} ] ( n ) - [ Δ {N}_{1} + \frac{{λ}_{2}}{{λ}_{1}} Δ {N}_{2} - 2 \frac{{λ}_{2}}{{λ}_{1}} Δ {N}_{3} ] ( n - 1 ) + Δ I ( n ) , \qquad ( 13 )$$
where Δφ_{STPIR} represents the three-frequency STPIR cycle slip detection variable, and ΔI(n)=I₁₂₃(n)−2I₁₂₃(n−1)+I₁₂₃(n−2) represents an ionospheric residual second-order term; and
step 5-4, determining a root mean square error of the three-frequency STPIR cycle slip detection variable, and determining the three-frequency STPIR cycle slip detection threshold according to the root mean square error of the three-frequency STPIR cycle slip detection variable, wherein the root mean square error of the three-frequency STPIR cycle slip detection variable is determined according to a formula (14):
$${σ}_{STPIR} = 2 \sqrt{{σ}_{φ}^{2} + {( \frac{{λ}_{2}}{{λ}_{1}} )}^{2} {σ}_{φ}^{2} + 4 {( \frac{{λ}_{3}}{{λ}_{1}} )}^{2} {σ}_{φ}^{2}} \approx 5.988 {σ}_{φ} , \qquad ( 14 )$$
where represents the root mean square error of the three-frequency STPIR cycle slip detection variable, three times of the root mean square error of the three-frequency STPIR cycle slip detection variable is taken as the three-frequency STPIR cycle slip detection threshold, and in a situation that the three-frequency STPIR cycle slip detection variable is beyond the three-frequency STPIR cycle slip detection threshold, it is considered that a cycle slip occurred.

6. The three-frequency cycle slip detection method of the BDS based on Doppler integration assistance according to claim 1, wherein the three-frequency cycle slip solution equations are expressed as a formula (15):
$$\{ \begin{matrix}Δ {\hat{N}}_{{i}_{1} , {j}_{1} , {k}_{1}} = {i}_{1} Δ {N}_{1} + {j}_{1} Δ {N}_{2} + {k}_{1} Δ {N}_{3} \\ Δ {\hat{N}}_{{i}_{2} , {j}_{2} , {k}_{2}} = {i}_{2} Δ {N}_{1} + {j}_{2} Δ {N}_{2} + {k}_{2} Δ {N}_{3} \\ {Δφ}_{S T P I R} = Δ {N}_{1} + \frac{{λ}_{2}}{{λ}_{1}} Δ {N}_{2} - 2 \frac{{λ}_{3}}{{λ}_{1}} Δ {N}_{3}\end{matrix} , \qquad ( 15 )$$
where (i₁, j₁, k₁) and (i₂, j₂, k₂) are the two groups of optimal three-frequency carrier phase combination coefficients.
